(19) United States
(12) Patent Application Publication
(10) Pub. No.: US 2015/0262191 A1
(43) Pub. Date: Sep. 17, 2015

(54) SYSTEM AND METHOD FOR ENSURING RECORDKEEPING COMPLIANCE

(71) Applicant: Bloomberg Finance L.P., New York, NY (US)

(72) Inventor: John WAANDERS, New York, NY (US)

(73) Assignee: Bloomberg Finance L.P., New York, NY (US)

(21) Appl. No.: 14/643,460

(22) Filed: Mar. 10, 2015

Related U.S. Application Data
(60) Provisional application No. 61/951,153, filed on Mar. 11, 2014.

(51) Int. Cl. G06Q 30/00

(52) U.S. Cl. CPC G06Q 30/018; G06Q 40/04

(57) ABSTRACT

Methods and systems for associating call data and trade data are disclosed. Initiation of a call between a client and a dealer is detected. The call is recorded. A trade is confirmed between the client and the dealer. The call is associated with the confirmed trade.

### BACKGROUND

In order to comply with certain rules set by the United States Commodity Futures Trading Commission (CFTC), audio records of transactions must be kept. The rules are meant to assist the CFTC's enforcement unit determine trader or client/dealer intent when investigating alleged wrongdoing. Enforcement investigations are made more efficient by recording quotes, bids, offers, trading and prices that may lead to transactions whether communicated by telephone, voicemail, mobile, or other electronic media.

### SUMMARY

Embodiments of the present disclosure facilitate the recording of calls dealing with financial instruments and the association of supporting data or trade data with the recorded call data.

In accordance with an embodiment of the present disclosure, initiation of a call between a client and a dealer is detected. The call is recorded. A trade between the client and the dealer is confirmed. The call is associated with the confirmed trade.

In accordance with an embodiment of the present disclosure, the execution confirmation of the trade between the client and the dealer includes analyzing trade recap information received from the dealer and receiving an affirmation indication from the client to indicate a confirmed trade.

In accordance with an embodiment of the present disclosure, associating the call with the confirmed trade includes analyzing a plurality of calls between the client and a plurality of dealers; identifying calls between the client and the dealer from the plurality of dealers; and processing the identified calls to determine the call related to the confirmed trade.

In accordance with an embodiment of the present disclosure, additional calls between the client and the dealer may be associated with the confirmed trade.

In accordance with an embodiment of the present disclosure, recording the call includes analyzing the call to determine whether the call relates to a trade of a financial instrument; and recording the call based on the analyzing.

In accordance with an embodiment of the present disclosure, associating the call with the confirmed trade includes analyzing the call to determine whether the call includes content associated with the confirmed trade.

The embodiments described herein may furthermore be carried out on a computing device that performs operations based on execution of non-transitory computer readable medium having executable code stored thereon.

In accordance with an embodiment of the present disclosure, a non-transitory computer readable medium having executable code stored thereon, that when executed, causes a computing device to perform at least the following operations: detecting initiation of a call between a client and a dealer; recording the call; confirming a trade between the client and the dealer; and associating the call with the confirmed trade.

The embodiments described herein may furthermore be carried out on a system comprising at least a communication unit and a recording unit. The communication unit, in communication with a network, is configured for: detecting initiation of a call between a client and a dealer; confirming a trade between the client and the dealer; and associating the call with the confirmed trade. The recording unit, in communication with the network, is configured for recording the call.

The aforementioned embodiments and other advantages of the embodiments described herein will be apparent to those of ordinary skill in the art at least by reference to this summary, the following detailed description, and the accompanying drawings.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIG. 1 illustrates a diagram of an exemplary diagram in which the embodiments of the present disclosure may be implemented;

FIG. 2 illustrates an exemplary diagram showing exemplary interactions between a client and dealers in accordance with the embodiments described herein;

FIG. 3 illustrates an exemplary user interface for initiating calls in accordance with the embodiments described herein;

FIG. 4 illustrates an exemplary user interface for receiving calls in accordance with the embodiments described herein;

FIG. 5 illustrates an exemplary user interface for showing a trade recap in accordance with the embodiments described herein;

FIG. 6 illustrates an exemplary user interface for associating calls with an affirmed trade in accordance with the embodiments described herein;

FIG. 7 illustrates an exemplary user interface for showing a trade recap in accordance with the embodiments described herein;

FIG. 8 illustrates an exemplary diagram showing exemplary interactions between a client and dealers in accordance with the embodiments described herein;

FIG. 9 illustrates an exemplary diagram showing exemplary interactions between a client and dealers in accordance with the embodiments described herein;

FIG. 10 illustrates an exemplary user interface for showing a trade recap in accordance with the embodiments described herein;

FIG. 11 illustrates an exemplary user interface for showing trades in accordance with the embodiments described herein;

FIG. 12 illustrates an exemplary user interface for showing trades in accordance with the embodiments described herein;

FIG. 13 illustrates an exemplary user interface for showing trade details in accordance with the embodiments described herein;

FIG. 14 illustrates an exemplary user interface for showing trade details in accordance with the embodiments described herein;

FIG. 15 illustrates an exemplary compliance unit in accordance with the embodiments described herein;

FIG. 16 illustrates another exemplary flow diagram showing an algorithm in accordance with the embodiments described herein;

FIG. 17 illustrates a high-level diagram of a computing device that may be used to implement various aspects of the present disclosure.

### DETAILED DESCRIPTION

Detailed embodiments of the present disclosure are provided herein. Any and all disclosed embodiments are merely exemplary and may be embodied in various and alternative forms, and combinations thereof. As used herein, “exemplary,” and similar terms, may refer expansively to embodiments that serve as an illustration, specimen, model, or pattern. The figures may include exaggerated or minimized features, in order to adequately show details of particular components. In certain instances, well-known components, systems, materials or methods that have not been described in detail in order to avoid obscuring from the focus of the present disclosure. Therefore, specific structural and functional details disclosed herein are in no way to be interpreted as limiting, but merely as a basis for the claims and as a representative basis recognizable to one skilled in the art to employ the present disclosure.

While the detailed description may include a general context of computer-executable instructions, the present disclosure may be implemented in combination with other program modules and/or as a combination of hardware and software. Thus, terms such as “computer” or “computing device” as used herein are expansive and are meant to include routines, program modules, programs, components, data structures, algorithms, and the like. Various systems may also be used for the implementation of the embodiments described herein, including single processor or multi-processor systems, minicomputers, mainframe computers, personal computers, hand-held computing devices, microprocessor-based computers, programmable consumer electronics, in-vehicle computing devices, and any of the aforementioned combinations thereof, and the like.

The U.S. Commodity Futures Trading Commission has enacted regulations regarding audio recordings related to trades of financial instruments to assist in determining trader intent in alleged wrongdoing. The regulations promote efficiency in preserving evidence. Quotes, bids, offers, trading and prices that lead to transactions communicated by telephone, voice mail, mobile or other electronic media may be recorded. However, with the new regulations, there exist issues in ensuring that the enormous amount of data to be tracked is stored in an organized fashion. A need exists to ensure that the correct records are associated with the correct trade, in particular phone calls or other audio recordings with affirmed trades.

In various embodiments, the present disclosure describes systems and methods for associating call data with trade data in order to comply with recordkeeping compliance rules. Initiation of a call between a client and a dealer is detected. The call is recorded. A trade between the client and the dealer is confirmed. The call is associated with the confirmed trade.

Typically, a trade takes place after a call between a client and a dealer. Either the client or the dealer can initiate the call. Once the call has been established between both parties, the call can be recorded. The phone systems of either the client or the dealer or both may be coupled to a system in accordance with an embodiment of the present arrangement, which is capable of allowing a user to initiate calls, record calls upon call establishment, and provide a user interface for affirming a trade. Various details of the trade may be discussed during the call, all of which will be recorded. These details may be memorialized through the user interface and sent by the dealer to the client or vice versa. If the trade details are confirmed, the recorded call can then be associated with the confirmed trade. The association of the call with confirmed trade, including trade recap details forms a record relating to the trade, including the recorded call.

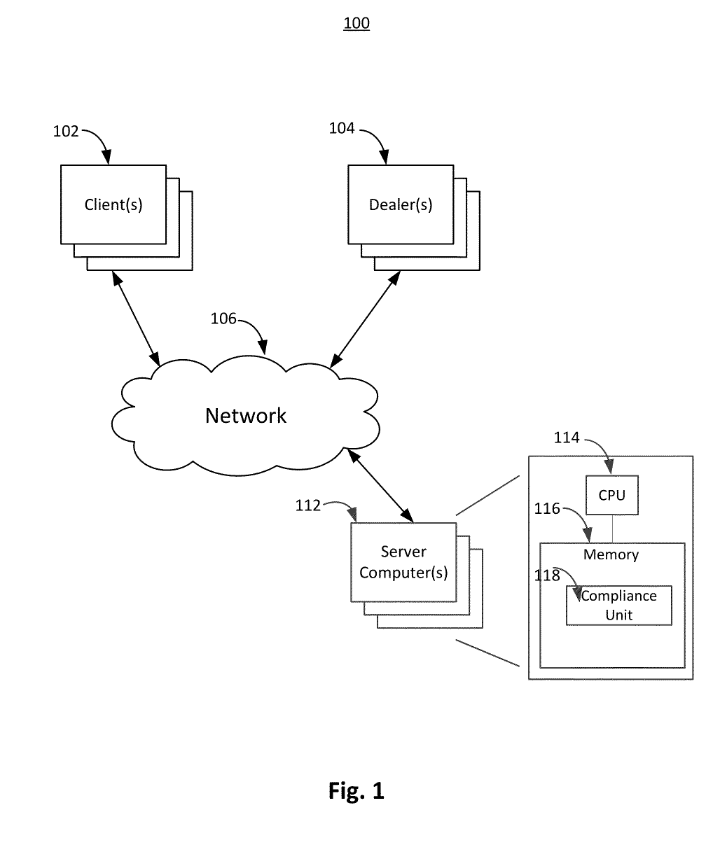

FIG. 1 illustrates a diagram of an exemplary diagram in which the embodiments of the present disclosure may be implemented. More specifically, system 100, as shown in FIG. 1 includes a network 106, and one or more server computers 112, which may, for example, belong to a brokerage firm or technology services provider, connected via network 106 to various other computing devices, servers, databases, networks, and the like, such as one or more clients 102 (e.g., money managers, advisers, end-clients, buy side traders, buy side clients, sell side clients, etc.), and one or more dealers 104. While these components are shown, they are not all required to practice the various embodiments described herein, and variations or substitutions in the arrangement and type of the components may be made. Server(s) 112 may vary widely in configuration or capabilities, but generally may include, a CPU 114 coupled to memory 116. One or more server computers 112 may also include one or more wired or wireless network interfaces (not shown), one or more input/output interfaces (not shown), or one or more operating systems (not shown), such as Windows Server, Mac OS X, Unix, Linux, FreeBSD, or the like. Memory 116, which may include volatile or non-volatile memory, may have stored thereon a compliance unit 118 in accordance with the embodiments described herein. Compliance unit 118 is intended to broadly include all programming, applications, algorithms, software and other tools necessary to implement or facilitate the embodiments described herein. The elements of compliance unit 118 may furthermore reside or exist on a single server computer or be distributed among multiple server computers or devices. Devices capable of operating as a server may include, as examples, dedicated rack-mounted servers, desktop computers, laptop computers, integrated devices combining various features of the aforementioned computing devices, such as two or more features of the foregoing devices, or the like.

Network 106 is configured to couple network devices with other computing devices. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within network 106. Furthermore, remote computers and other related electronic devices could be remotely connected to either LANs or WANs via a modem and temporary telephone link. In essence, network 106 includes any communication method by which information may travel between computing devices.

In accordance with an embodiment, compliance unit 118, which may include at least a communication unit and recording unit, is configured for detecting initiation of a call between a client and a dealer; recording the call; confirming a trade between the client and the dealer; and associating the call with the confirmed trade. Compliance unit 118 may be configured to communicate with a telecommunications device for making calls between client 102 and dealer 104. As a result, compliance unit 118 may detect initiation of a call between client 102 and dealer 104 for the purpose of discussing a trade of a financial instrument. Either client 102 or dealer 104 may initiate the call to establish communication between the respective parties. Once compliance unit 118 has detected a call between client 102 and dealer 104, the call is recorded. Based on details discussed on the call between client 102 and dealer 104, a trade may be confirmed between client 102 and dealer 104. A user interface may be provided by server computer 112 to allow either client 102 or dealer 104 to input details pertaining to the trade and send a trade recap to the other party to allow the other party to affirm the trade. Once the trade is affirmed or confirmed, the recorded call is associated with the confirmed trade to form a complete record of the trade for compliance recordkeeping purposes. When compliance unit 118 receives an indication that the trade is confirmed, an association is created between the recorded call and any other information relating to the trade.

In accordance with an embodiment, compliance unit 118 may also analyze trade recap information received from the dealer 104 sent to the client 102 to parse details of the trade; and receive an affirmation indication from the client 102 to indicate that a confirmed trade. This allows compliance unit 118 to know that a trade has indeed been completed and affirmed, and that the trade can be the basis for a record including trade details and any recorded calls associated with the trade.

In accordance with an embodiment, compliance unit 118 may analyze a plurality of calls between client 102 and dealer 104. Multiple calls may be required between client and dealer before a trade takes place and trade details can be confirmed. In certain instances, a client may call several dealers to obtain quotes before moving forward with one dealer. In other instances, a client may have multiple calls with a single dealer to work out details of the trade. Furthermore, in certain situations a dealer may not initially respond to a client and will have to call the client back, thus creating additional calls which may need to be associated with a confirmed trade. Specific calls between client 102 and a specific dealer 104 from a plurality of dealers may be identified for the purpose of associating a recorded call with a confirmed trade. Once these calls between client 102 and dealer 104 are identified, the identified calls may be processed to determine which call, if any is related to the confirmed trade. The calls may be processed to determine if they contain certain trade details matching the confirmed trade. All calls with matching information may thereafter be associated with the confirmed trade.

In accordance with an embodiment, compliance unit 118 may associate additional calls between the client 102 and dealer 104 with the confirmed trade. Additional calls may be required after a first initially recorded call that is associated with a confirmed trade. Either the client 102 or dealer 104 may associate any additional calls with the confirmed through a user interface accessible via server computer 112.

In accordance with an embodiment, compliance unit 118 may analyze the call to determine whether the call actually relates to a trade of a financial instrument; and record the call only if the analysis reveals that the call discusses trading of a financial instrument. Client 102 and dealer 104 may enter a situation where they call each other to discuss other matters, or only casually mention details relating to trading but not any particular trade. Compliance unit 118 may analyze details from the call, and if it is determined that there is no trade of a financial instrument discussed, opt to not record the call.

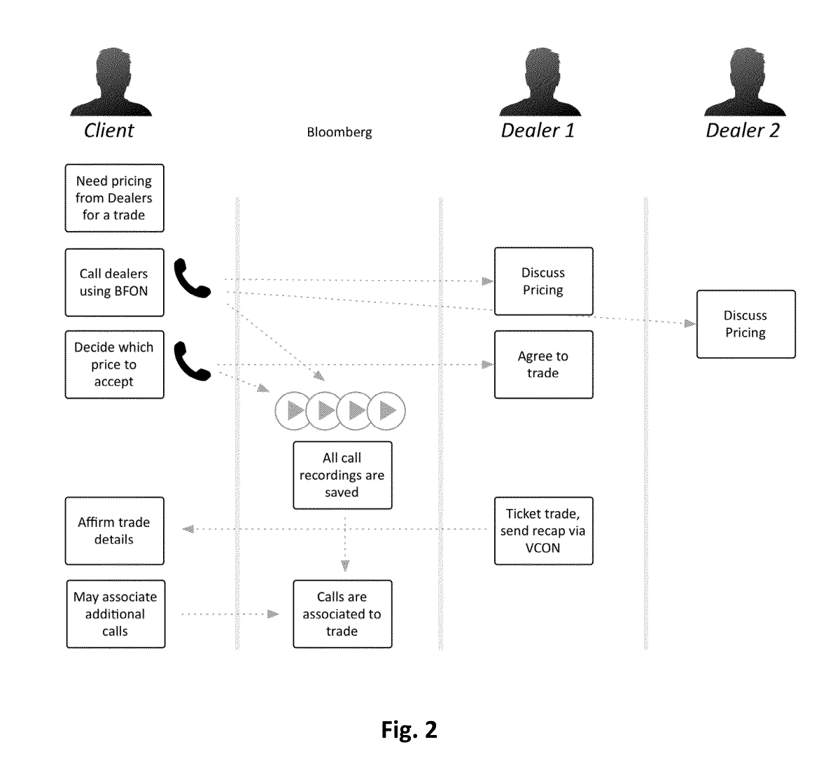

FIG. 2 illustrates an exemplary block diagram showing exemplary interactions between the principal parties in accordance with the embodiments described herein. Diagram 200 illustrates an exemplary workflow of recording a call between a client and dealer in relation to trading of a financial instrument, gathering details related to the trade and associating trade information of a confirmed trade with a corresponding call discussing details of the trade. Client 102 may begin in a situation where he/she requires pricing from various dealers in order to complete a trade. Via a computing system such as one hosted by server computer 112, client 102 may initiate a call to dealers using a call functionality provided by server computer 112. For example, client 102 may make calls to two dealers 202 and 204 through a user interface provided by server computer 112. One call each may be placed to dealer 202 and dealer 204 respectively, with both calls recorded as pricing information regarding a financial instrument is discussed. When client 102 is in a position to discuss which price to accept from dealer 202 or dealer 204, client 102 will make a call to that dealer and accept the price. At this point, the dealer (in this example, dealer 202), may agree to the trade. Thus far, all calls between client 102 and dealer 202 or dealer 204 have been recorded and saved.

Dealer 202 sends a ticket trade recap to client 102 for client 102 to affirm the details. Once the details are affirmed, calls associated with the trade detailed in the ticket trade recap are then associated with the trade. Client 102 will furthermore have the opportunity to associate any additional calls which may have been recorded previously or that have not been automatically associated with the trade.

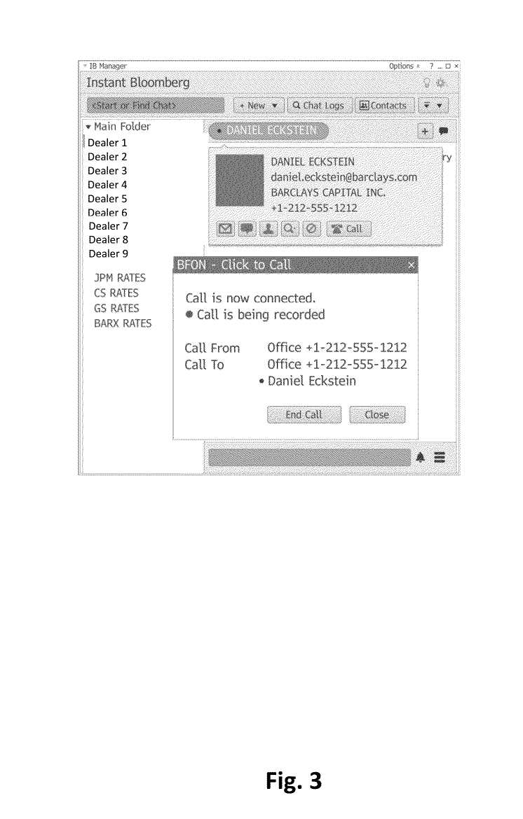

FIG. 3 illustrates an exemplary user interface for initiating calls in accordance with the embodiments described herein. The user interface shown may be accessed through a server computer 112 by either a client or a dealer to initiate a call. The user interface shown shows what a typical caller would see when initiating a call. As shown, once a call has been initiated, an indication that the call is connected and being recorded is shown.

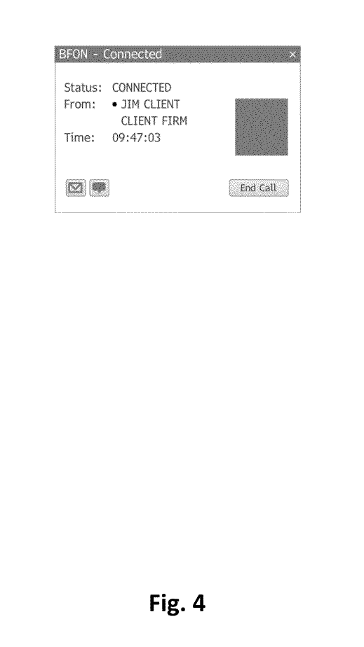

FIG. 4 illustrates an exemplary user interface for receiving calls in accordance with the embodiments described herein. The user interface shown may be accessed through a server computer 112 by either a client or a dealer who has received a call. The user interface shows who the call is from and that a call is currently taking place.

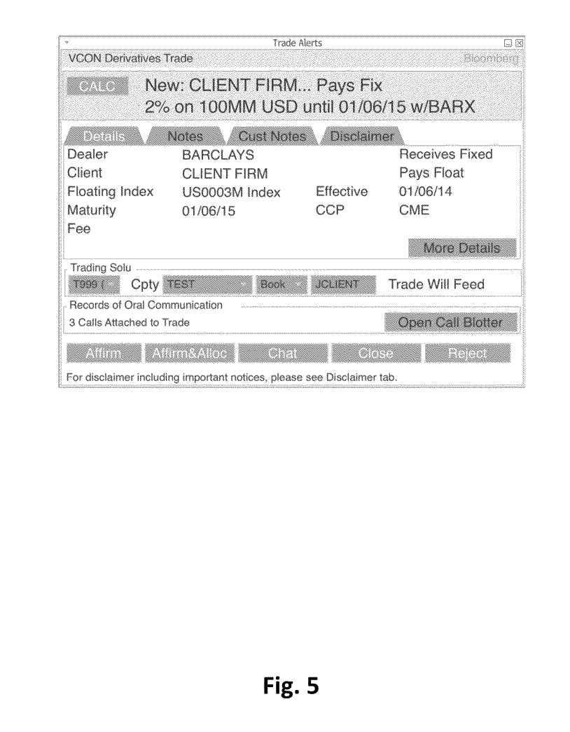

FIG. 5 illustrates an exemplary user interface for showing a trade recap in accordance with the embodiments described herein. The user interface shown may be accessed through a server computer 112 by either a client or a dealer who agrees to a trade. The user interface shows all relevant trade details as well as records of oral communication. As shown, the user interface indicates that 3 calls have been attached to the particular trade recap information.

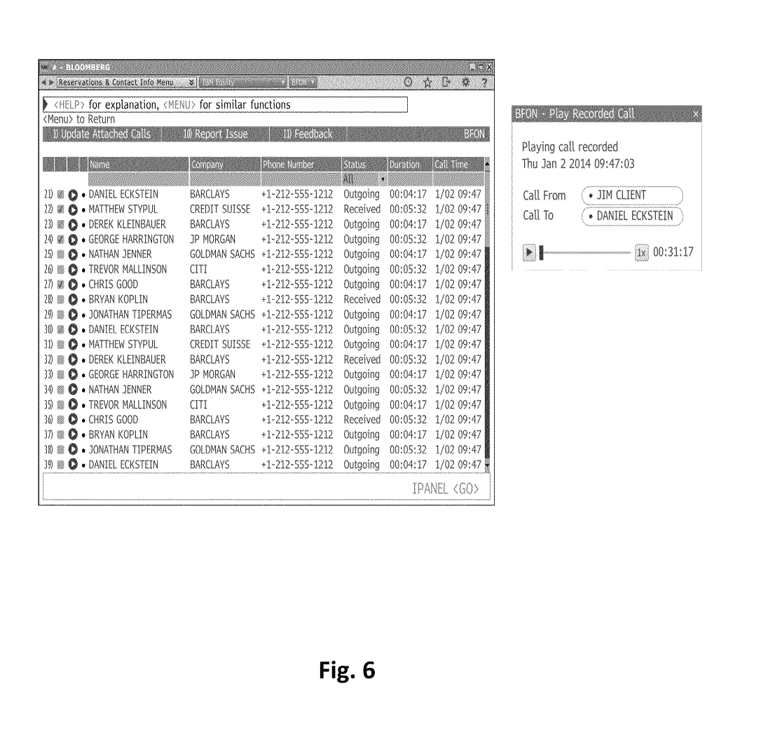

FIG. 6 illustrates an exemplary user interface for associating calls with an affirmed trade in accordance with the embodiments described herein. The user interface shown and accessed through a server computer 112 by a client or dealer, will allow a client to view all logged and recorded calls and play back any of the calls. This allows a client or dealer the ability to associate additional calls with trades, and provides an efficient calls recordkeeping database complete with name of called party, company, phone number, status (outgoing or received), duration, and call time. A user may also be allowed to select calls to further associate with trade recap information.

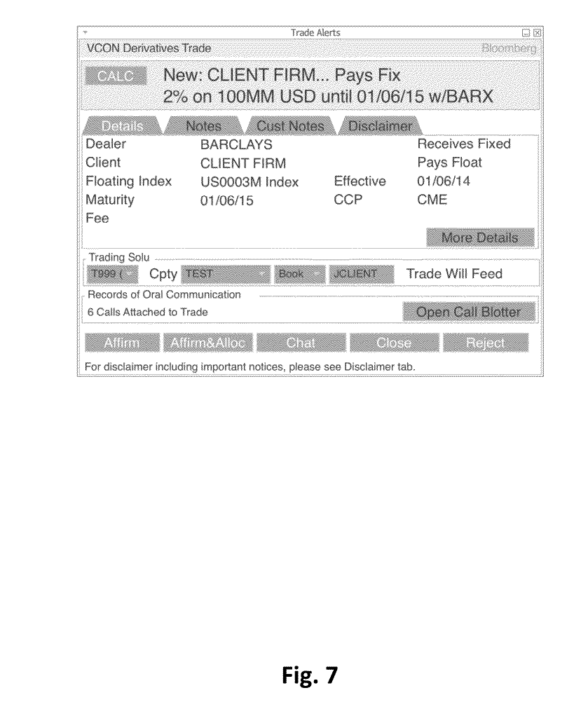

FIG. 7 illustrates an exemplary user interface for showing a trade recap in accordance with the embodiments described herein. The user interface shown is the same as that shown in FIG. 5, except more calls have been associated with the trade. The user interface shows 6 calls associated with the trade details shown by the trade recap information.

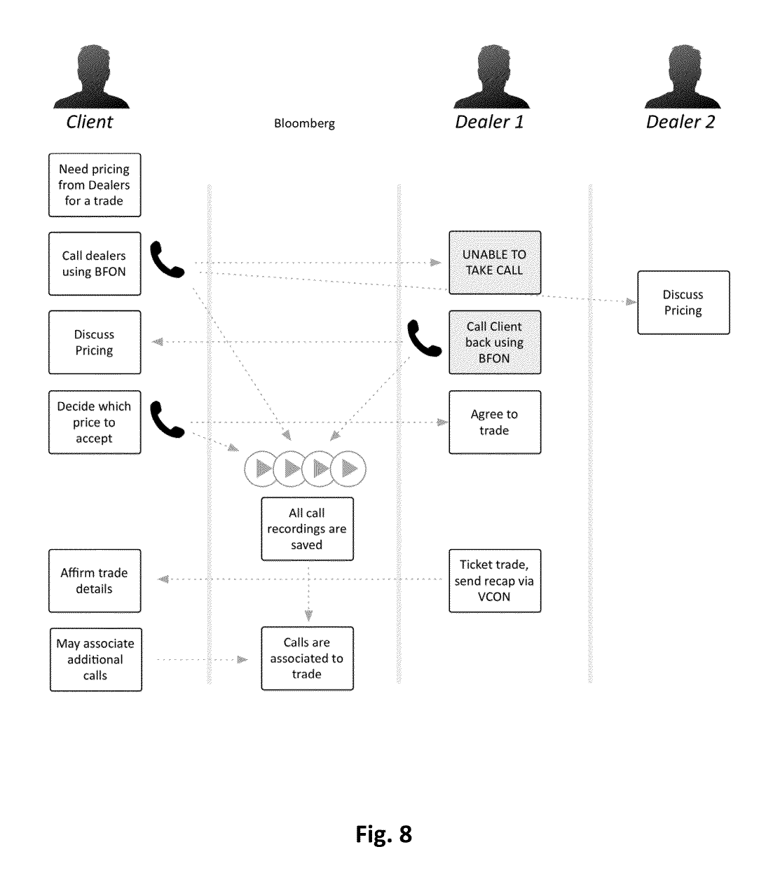

FIG. 8 illustrates an exemplary diagram showing exemplary interactions between a client and dealers in accordance with the embodiments described herein. Diagram 800 illustrates an exemplary workflow of recording a call between a client and dealer in relation to trading of a financial instrument, gathering details related to the trade and associating trade information of a confirmed trade with a corresponding call discussing details of the trade. Client 102 may begin in a situation where he/she requires pricing from various dealers in order to complete a trade. Via a computing system such as one hosted by server computer 112, client 102 may initiate a call to dealers using a call functionality provided by server computer 112. For example, client 102 may make calls to two dealers 802 and 804 through a user interface provided by server computer 112. One call each may be placed to dealer 802 and dealer 804 respectively, however in this instance only the call to dealer 804 by client 102 is recorded because dealer 802 was unable to take the call from client 102. Dealer 802 can later call back client 102 to discuss pricing for a prospective trade. Client 102 may then make a decision regarding pricing and call back one of the dealers to accept the price for the trade. Client 102 decides to call dealer 802 and dealer 802 agrees to the trade. At this point, all are recorded based on including details relevant to trading of a financial instrument.

Dealer 202 sends a ticket trade recap to client 102 for client 102 to affirm the details. Once the details are affirmed, calls associated with the trade detailed in the ticket trade recap are then associated with the trade. Client 102 will furthermore have the opportunity to associate any additional calls which may have been recorded previously or that have not been automatically associated with the trade.

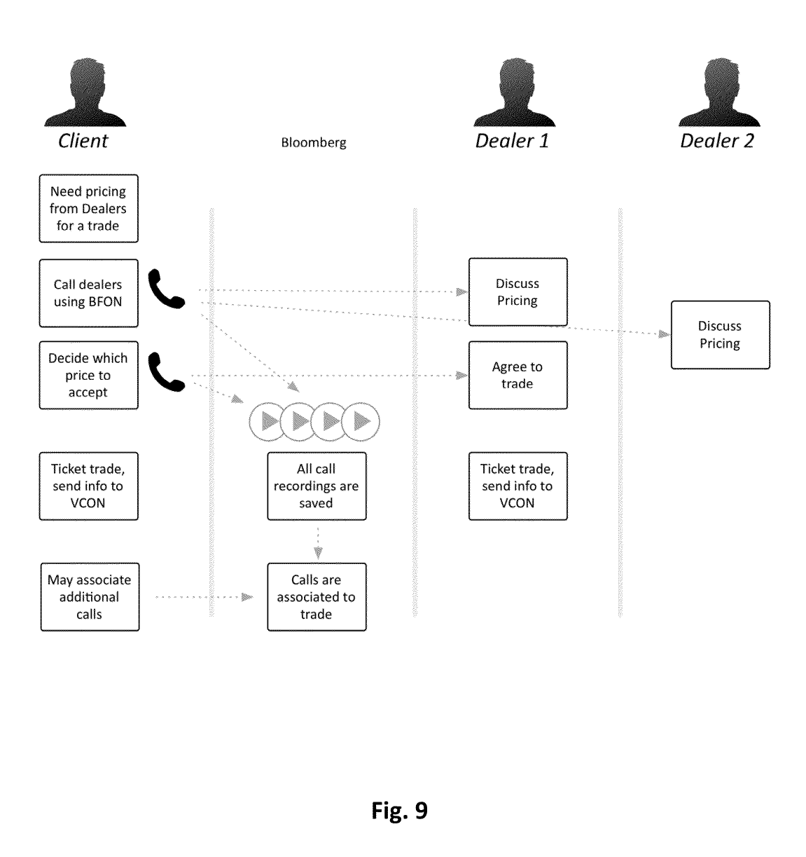

FIG. 9 illustrates an exemplary block diagram showing exemplary interactions between the principal parties in accordance with the embodiments described herein. Diagram 900 illustrates an exemplary workflow of recording a call between a client and dealer in relation to trading of a financial instrument, gathering details related to the trade and associating trade information of a confirmed trade with a corresponding call discussing details of the trade. Client 102 may begin in a situation where he/she requires pricing from various dealers in order to complete a trade. Via a computing system such as one hosted by server computer 112, client 102 may initiate a call to dealers using a call functionality provided by server computer 112. For example, client 102 may make calls to two dealers 902 and 904 through a user interface provided by server computer 112. One call each may be placed to dealer 902 and dealer 904 respectively, with both calls recorded as pricing information regarding a financial instrument is discussed. When client 102 is in a position to discuss which price to accept from dealer 902 or dealer 904, client 102 will make a call to that dealer and accept the price. At this point, the dealer (in this example, dealer 902), may agree to the trade. Thus far, all calls between client 102 and dealer 902 or dealer 904 have been recorded and saved.

Dealer 902 can create a ticket trade recap including trade information details that can be provided to server computer 112. Similarly client 102 can also create a ticket trade recap including trade information details that can be provided to server computer 112. Once the details are affirmed, calls associated with the trade detailed in the ticket trade recap are then associated with the trade. Client 102 will furthermore have the opportunity to associate any additional calls which may have been recorded previously or that have not been automatically associated with the trade.

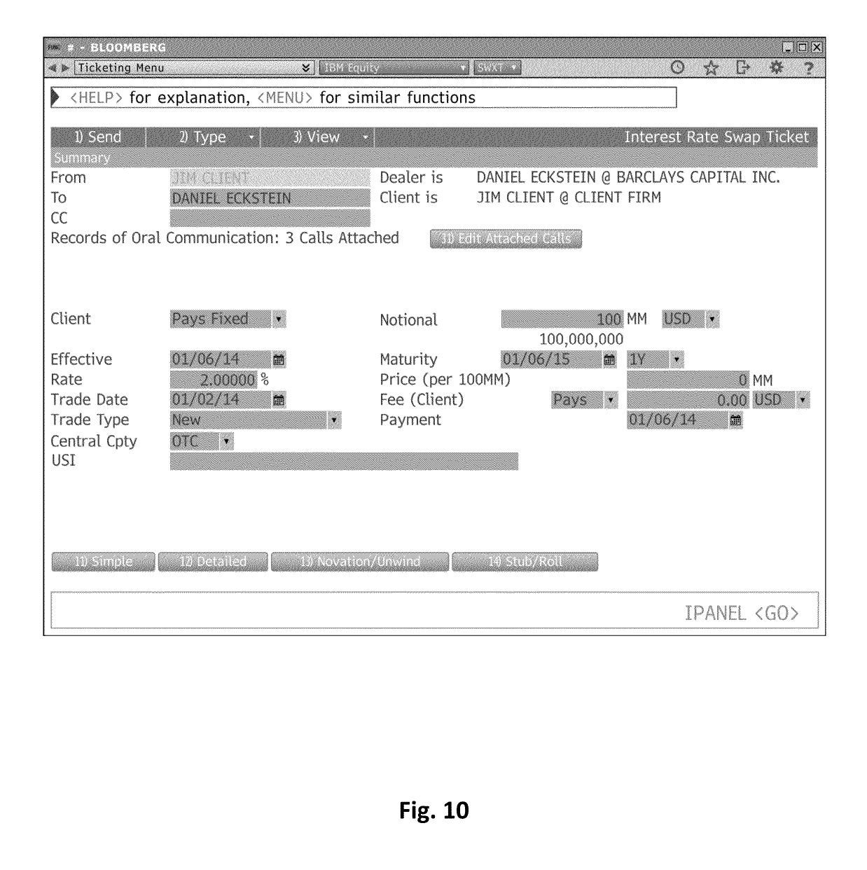

FIG. 10 illustrates an exemplary user interface for showing a trade recap in accordance with the embodiments described herein. The user interface shown may be accessed through a server computer 112 by either a client or a dealer who agrees to a trade. The user interface shows all relevant trade details as well as records of oral communication. As shown, the user interface indicates that 3 calls have been attached to the particular trade recap information.

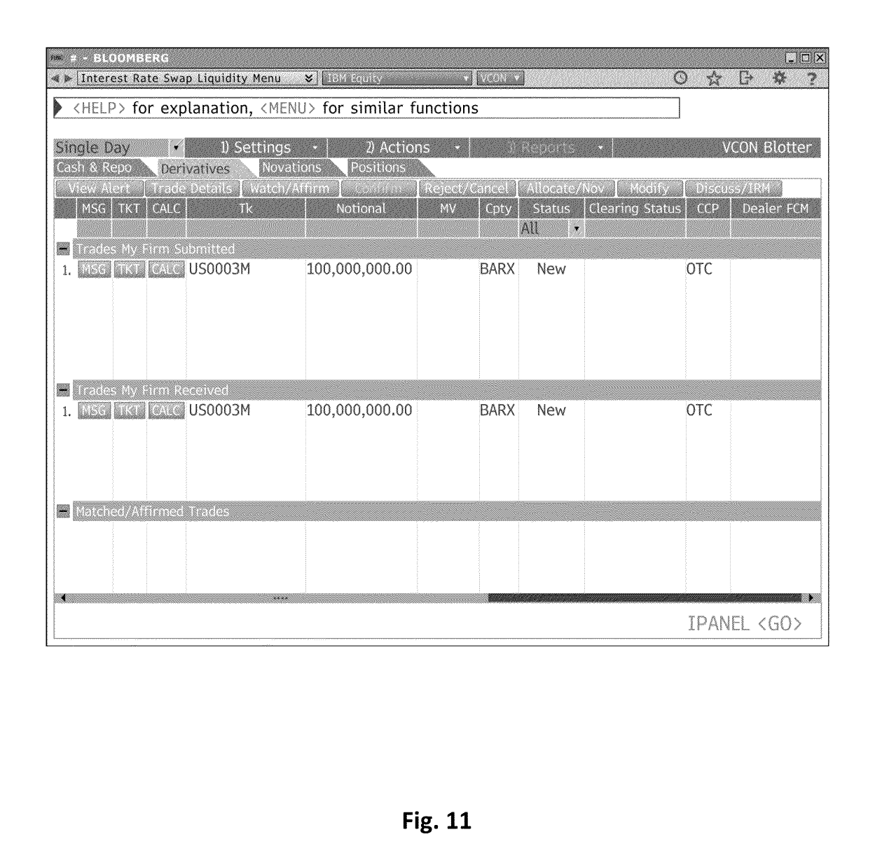

FIG. 11 illustrates an exemplary user interface for showing trades in accordance with the embodiments described herein. The user interface shown may be accessed through a server computer 112 by either a client or a dealer who wishes to view trades submitted and received as well as matched/affirmed trades by their respective firm.

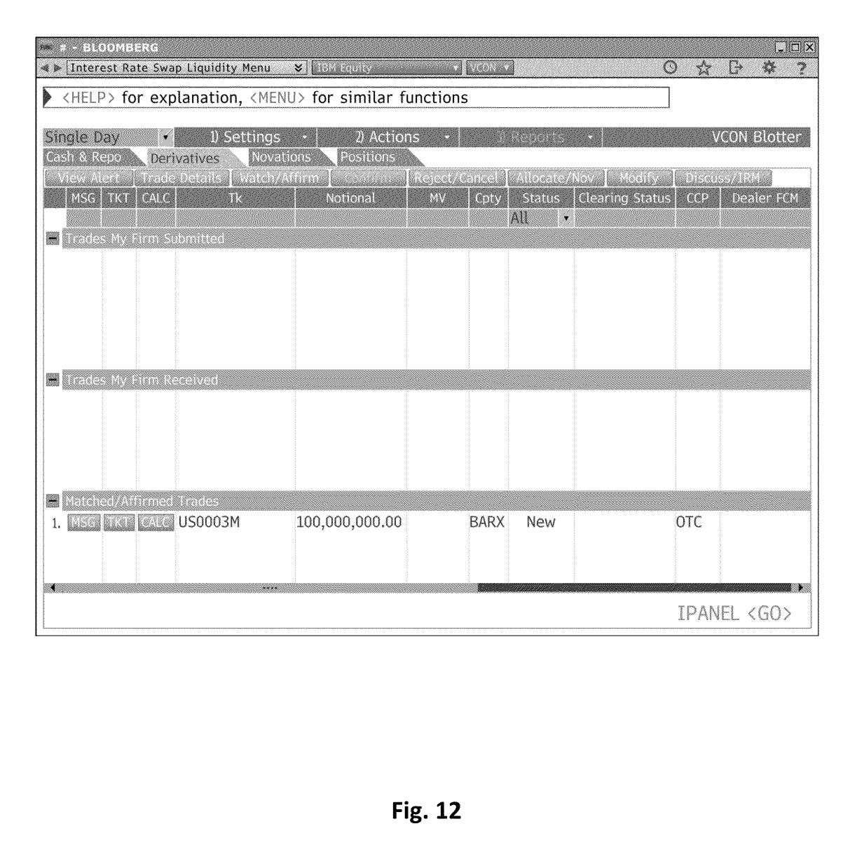

FIG. 12 illustrates an exemplary user interface for showing trades in accordance with the embodiments described herein. The user interface shown may be accessed through a server computer 112 by either a client or a dealer who wishes to view trades submitted and received as well as matched/affirmed trades by their respective firm.

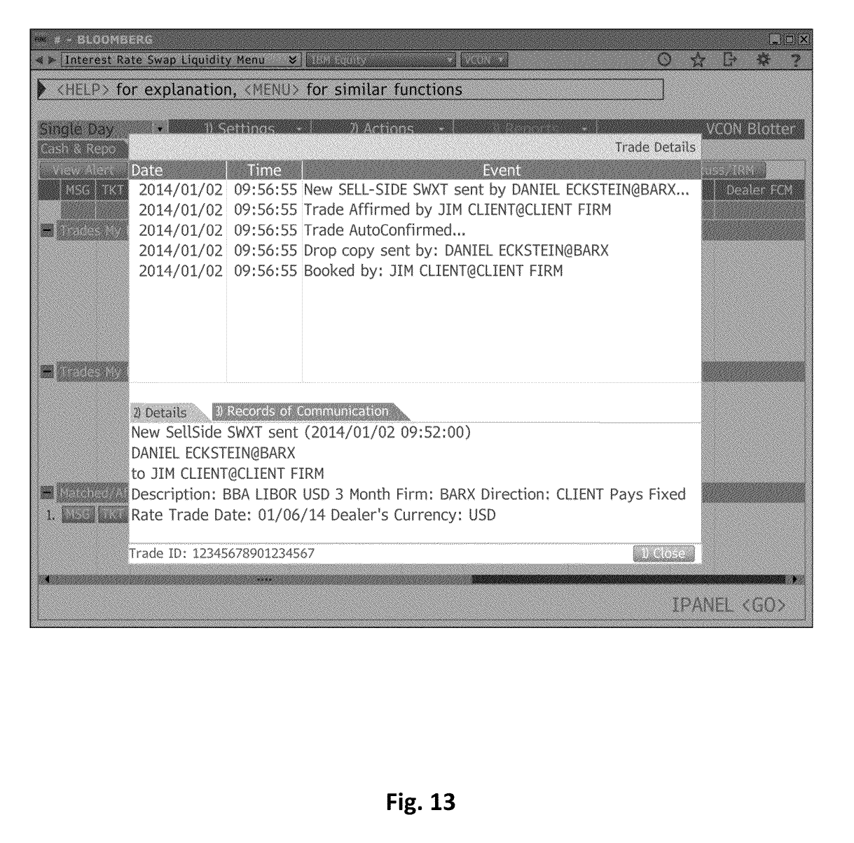

FIG. 13 illustrates an exemplary user interface for showing trade details in accordance with the embodiments described herein. The user interface shown may be accessed through a server computer 112 by either a client or a dealer who wishes to view trades submitted and received as well as matched/affirmed trades by their respective firm. Upon selection of a trade, further trade details may be displayed, as shown, including specific information about the trade.

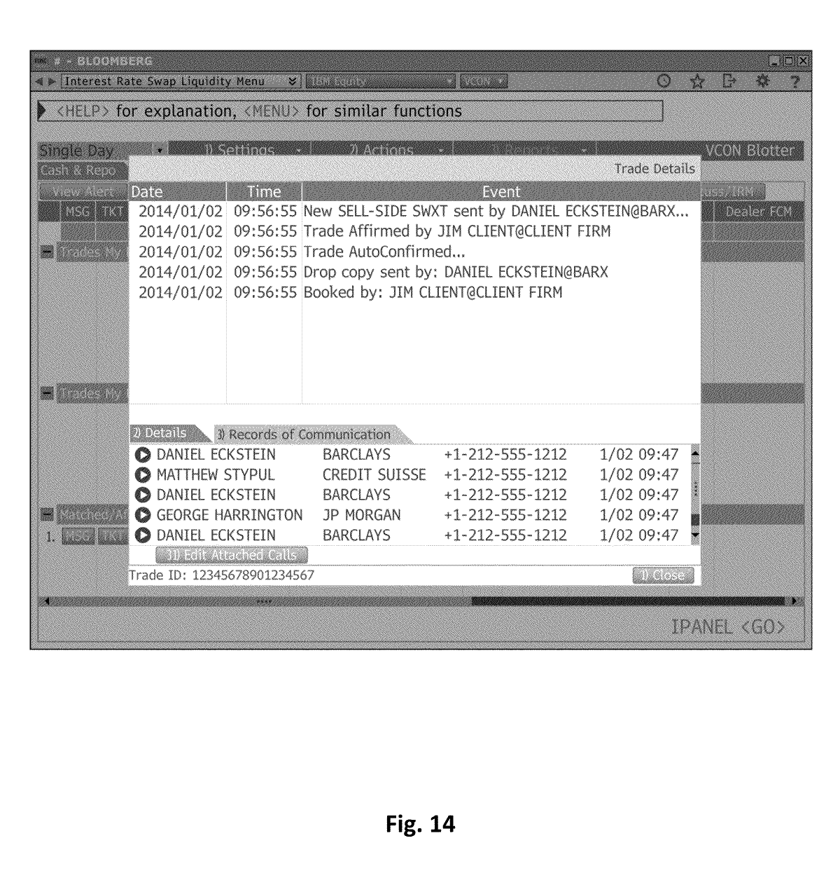

FIG. 14 illustrates an exemplary user interface for showing trade details in accordance with the embodiments described herein. The user interface shown may be accessed through a server computer 112 by either a client or a dealer who wishes to view trades submitted and received as well as matched/affirmed trades by their respective firm. Upon selection of a trade, further trade details may be displayed, as shown, including specific information about the trade, as well as information regarding calls associated with the trade.

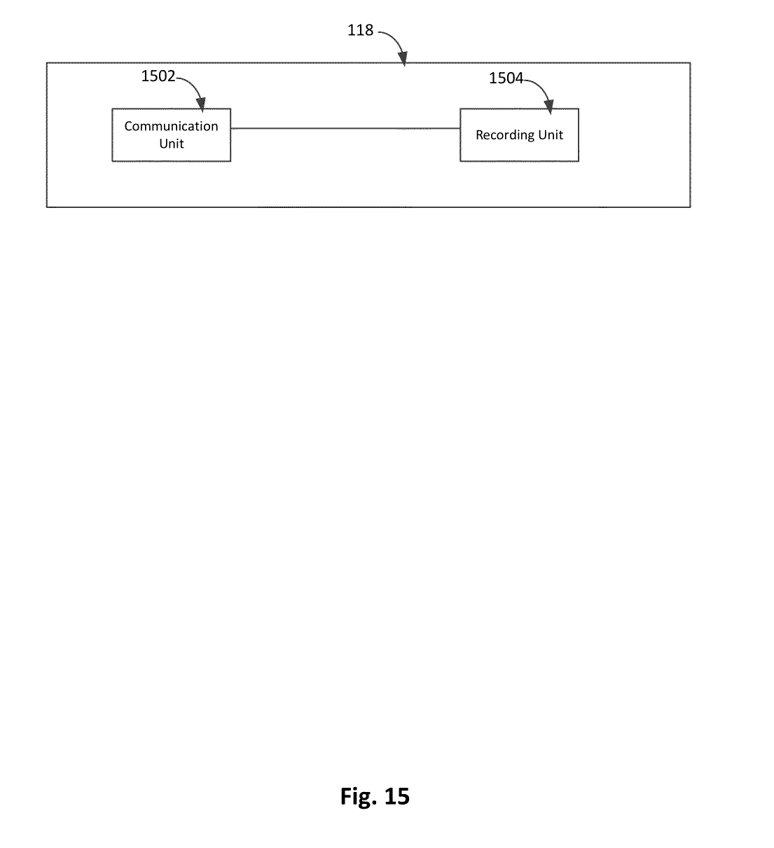

FIG. 15 illustrates an exemplary compliance unit in accordance with the embodiments described herein. Compliance unit 118 may include a communication unit 1502 and recording unit 1504. Communication unit 1502 is configured for detecting initiation of a call between a client and a dealer; confirming a trade between the client and the dealer; and associating the call with the confirmed trade. Recording unit 1504 is configured for recording the call. Both communication unit 1502 and recording unit 1504 are in communication with a network. When a client and a dealer wish to make a trade, either of them may initiate a call to the opposing party to discuss pricing or other specifics of a potential trade. A client may also call multiple dealers to discuss pricing before selecting one to consummate a trade with. All calls may be recorded by recording unit 1504.

Communication unit 1502 may also be configured for analyzing calls to determine whether the calls relate to a trade of financial instruments. Calls may then be recorded by recording unit 1504 based on this analysis so irrelevant calls or casual calls made without the purpose of discussing trades can be exempted from recording.

Once a client agrees on a trade with a dealer on a call (or selects a dealer to complete a trade with dealer and calls the dealer to indicate this), trade details are generated through a user interface provided by compliance unit 118 to either the client or dealer. The other party will have the opportunity to affirm the details resulting in a confirmed trade. Confirmation of the trade between the client and the dealer may involve analyzing trade recap information received from the dealer by communication unit 1502 to be provided to the client, and receiving an affirmation indication from the client to indicate that the trade is confirmed.

After confirming a trade between client and dealer, the recorded call is associated with the confirmed trade by communication unit 1502. The association of trade information with the call assists with recordkeeping compliance and ensures that it is easy to match up calls discussing certain trades with the correct trade information.

In situations where there are several calls, communication unit 1502 analyzes a plurality of calls between the client and a plurality of dealers. Calls between the client and a particular dealer can be identified. The identified calls can then be processed to determine which calls are related to a confirmed trade.

In an embodiment, additional calls may also be associated between a client and dealer if either party believes that additional calls discussing the trade were not automatically associated with the affirmed trade. Communication unit 1502 may provide a user interface to a client or dealer including a list of calls between the two parties for selection and inclusion with trade recap information or trade details that are associated with at least one call between the parties.

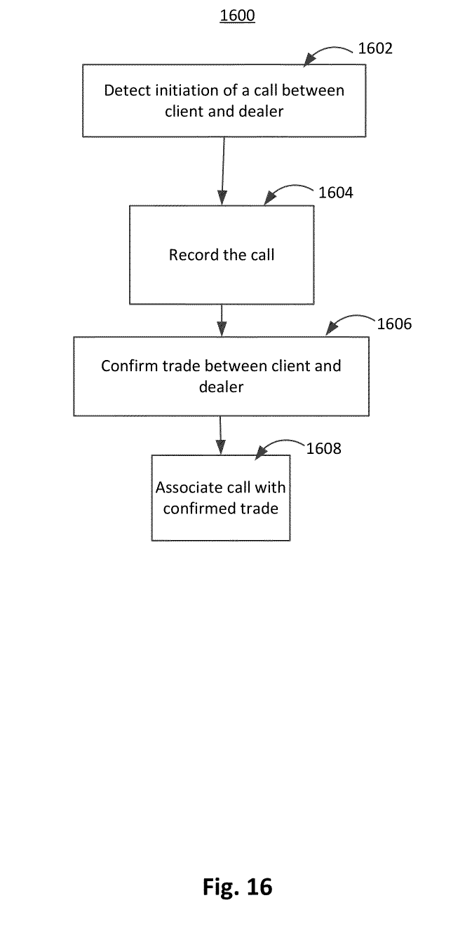

FIG. 16 illustrates an exemplary flow diagram showing an algorithm in accordance with the embodiments described herein. Method 1600, as shown, illustrates an algorithm for associating call data with trade data. In an embodiment, at step 1602, a compliance unit of a server system or computing device, such as compliance unit 118 may detect initiation of a call between a client and a dealer.

At step 1604, the call is recorded. At step 1606, the trade is confirmed between the client and the dealer. At step 1608, due to the confirmed trade, the recorded call may be associated with the confirmed trade. The recorded call associated with the confirmed trade provides a complete record of trade details, as described above, as well as the recorded call and possibly other calls to be referenced in relation to the trade.

It shall be understood that each block of a flowchart illustration need not be limited in the ordering shown in the illustration, and might be performed in any ordering, or even performed concurrently, without departing from the spirit of the embodiments described herein. It will also be understood that each block of the flowchart illustration, and combinations of blocks in the flowchart illustration, can be implemented by execution of computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

All systems and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

All systems and methods described herein may also be implemented using computers operating in a client-server relationship. Typically, in such a system, the client computer is located remotely from the server computer and interaction takes place via a network. The client-server relationship may be defined and controlled by computer programs executing on their respective client and server computers.

All systems and method described herein may also be used within a network-based cloud computing system. In such a network-based cloud computing system, a server or another processor that is connected to a network communicates with one or more client computers via a network. A client/dealer computer may communicate with the server via a network browser application residing and operating on the client/dealer computer, for example. A client/dealer computer may store data on the server and access the data via the network. A client/dealer computer may transmit requests for data, or requests for online services, to the server via the network. The server may perform requested services and provide data to the client/dealer computer(s). The server may also transmit data adapted to cause a client computer to perform a specified function, e.g., to perform a calculation, carry out an algorithm, to display specified data on a screen, etc. For example, the server may perform either at the server or cause a client/dealer to perform one or more of the method steps described herein, including at least the steps of FIG. 16. Certain steps of the method described herein may be performed by a server or by another processor in a network-based cloud-computing system. Certain steps of the methods described herein may be performed by a client/dealer computer in a network-based cloud computing system. The steps of the methods described herein may be performed by a server and/or by a client/dealer or computer in a network-based cloud computing system, in any combination thereof.

All systems and methods described herein may be implemented using a computer program product tangibly embodied in an information carrier, e.g., in a non-transitory machine-readable storage, for execution by a programmable processor; and the method steps described herein may be implemented using one or more computer programs executable by such processor. A computer program may be a set of computer program instructions that can be used, directly or indirectly, by a computer to perform a certain activity or bring about a certain result. A computer program may be written in any form of programming language, including compiled or interpreted languages, and may be deployed in any form, including as a stand-alone program or as a module, component, subroutine, or other unit suitable for use in a computing environment.

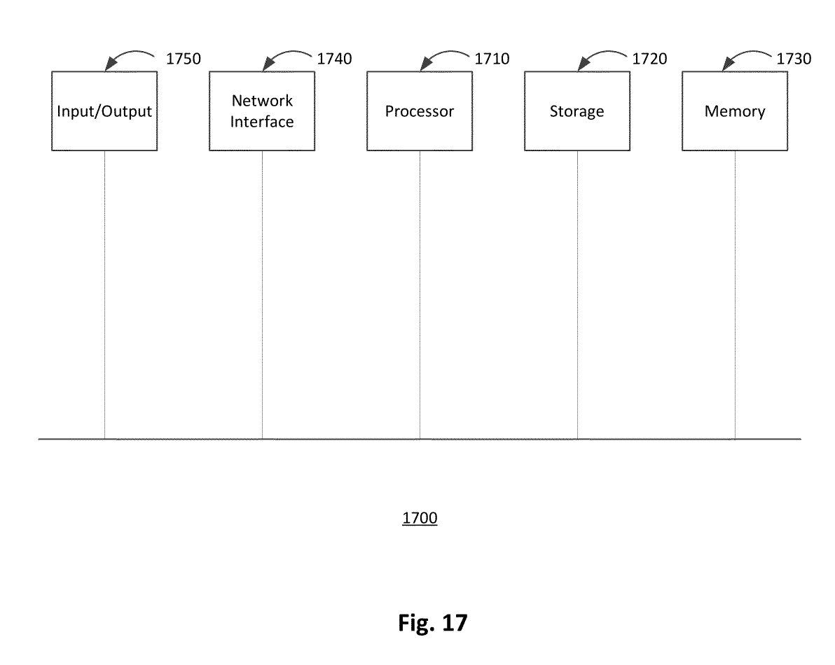

FIG. 17 illustrates a high-level diagram of a computing device that may be used to implement various aspects of the present disclosure. Computing device 1700 comprises a processor 1710 operatively coupled to a data storage device 1720 and a memory 1730. Processor 1710 controls the overall operation of computing device 1700 by executing computer program instructions that define such operations. The computer program instructions may be stored in data storage device 1720, or other computer readable mediums, and loaded into memory 1730 when execution of the computer program instructions is desired. Thus, at least the method steps of FIG. 16 can be defined by the computer program instructions stored in memory 1730 and/or data storage 1720 and controlled by processor 1710 executing the computer program instructions. For example, the computer program instructions can be implemented as computer executable code programmed by one skilled in the art to perform at least the algorithms defined by the method steps of FIG. 16. Computing device 1700 also includes one or more network interfaces for communicating with other devices via a network. Computing device 1700 also includes one or more input/output devices 1750 that enable user interaction with computing device 1700 (e.g., display, keyboard, mouse, speakers, buttons, etc.).

Processor 1710 may include both general and special purpose microprocessors, and may be the sole processor or one of multiple processors of computing device 1700. Processor 1710 may comprise one or more central processing units (CPUs), for example. Processor 1710, data storage device 1720, and/or memory 1730 may include, be supplemented by, or incorporated in, one or more application-specific integrated circuits (ASICs) and/or one or more field programmable gate arrays (FPGAs).

Data storage 1720 and memory 1730 each comprise a tangible non-transitory computer readable storage medium. Data storage 1720, and memory 1730, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1750 may include peripherals, such as a printer, scanner, display screen, etc. For example, input/output devices 1750 may include a display device such as a cathode ray tube (CRT) or liquid crystal display (LCD) monitor for displaying information to the user, a keyboard, and a pointing device such as a mouse or a trackball by which the user can provide input to computing device 1700.

Any or all of the systems described herein, including clients 102, dealers 104, and server computers 112 may be implemented using computing device 1700 or any equivalent device.

One skilled in the art will readily recognize that any implementation of an actual computer, computer system, or computing device may have other structures and may contain other components, and that computing device 1700 is merely a high level representation of some of the components for illustrative purposes.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

1. A non-transitory computer readable medium having executable code stored thereon, that when executed, causes a computing device to perform operations comprising:
detecting initiation of a call between a client and a dealer;
recording the call;
confirming a trade between the client and the dealer; and
associating the call with the confirmed trade.

2. The non-transitory computer readable medium of claim 1, wherein the operation of confirming a trade between the client and the dealer comprises:
analyzing trade recap information received from the dealer; and
receiving an affirmation indication from the client to indicate a confirmed trade.

3. The non-transitory computer readable medium of claim 1, wherein the operation of associating the call with the confirmed trade comprises:
analyzing a plurality of calls between the client and a plurality of dealers;
identifying calls between the client and the dealer from the plurality of dealers; and
processing the identified calls to determine the call related to the confirmed trade.

4. The non-transitory computer readable medium of claim 1, wherein the operation of recording the call comprises:
analyzing the call to determine whether the call relates to a trade of a financial instrument; and
recording the call based on the analyzing.

5. The non-transitory computer readable medium of claim 1, wherein the operation of associating the call with the confirmed trade comprises:
analyzing the call to determine whether the call includes content associated with the confirmed trade.

6. A method for associating call data with trade data, comprising:
detecting initiation of a call between a client and a dealer;
recording the call;
confirming a trade between the client and the dealer; and
associating the call with the confirmed trade.

7. The method of claim 6, wherein confirming a trade between the client and the dealer comprises:
analyzing trade recap information received from the dealer; and
receiving an affirmation indication from the client to indicate a confirmed trade.

8. The method of claim 6, wherein associating the call with the confirmed trade comprises:
analyzing a plurality of calls between the client and a plurality of dealers;
identifying calls between the client and the dealer from the plurality of dealers; and
processing the identified calls to determine the call related to the confirmed trade.

9. The method of claim 6, wherein recording the call comprises:
analyzing the call to determine whether the call relates to a trade of a financial instrument; and
recording the call based on the analyzing.

10. The method of claim 6, wherein associating the call with the confirmed trade comprises:
analyzing the call to determine whether the call includes content associated with the confirmed trade.

11. A system comprising:
a communication unit, in communication with a network, configured for:
detecting initiation of a call between a client and a dealer;
confirming a trade between the client and the dealer; and
associating the call with the confirmed trade; and
a recording unit, in communication with the network, configured for:
recording the call.

12. The system of claim 11, wherein the communication unit is further configured for:
analyzing trade recap information received from the dealer; and
receiving an affirmation indication from the client to indicate a confirmed trade.

13. The system of claim 11, wherein the communication unit is further configured for:
analyzing a plurality of calls between the client and a plurality of dealers;
identifying calls between the client and the dealer from the plurality of dealers; and
processing the identified calls to determine the call related to the confirmed trade.

14. The system of claim 11, wherein the communication unit is further configured for:
analyzing the call to determine whether the call relates to a trade of a financial instrument; and
wherein the recording unit is further configured for:
recording the call based on the analyzing.

15. The system of claim 11, wherein the communication unit is further configured for:
analyzing the call to determine whether the call includes content associated with the confirmed trade.
